(19) United States
(12) Patent Application Publication
(10) Pub. No.: US 2015/0135587 A1
(43) Pub. Date: May 21, 2015

(54) LANDSCAPING MATERIAL WITH WATER MANAGEMENT PROPERTIES

(71) Applicant: BASF Corporation, Florham Park, NJ (US)

(72) Inventors: Rebecca Lister, Ames, IA (US); Terry Potter, Ames, IA (US); Laura Beth Phillips, Pleasantville, IA (US)

(73) Assignee: BASF Corporation

(21) Appl. No.: 14/542,976

(22) Filed: Nov. 17, 2014

Related U.S. Application Data
(60) Provisional application No. 61/906,241, filed on Nov. 19, 2013.

(51) Int. Cl. B01J 20/32; B01J 20/24; B01J 20/22; A01C 21/00

(52) U.S. Cl. CPC B01J 20/3231; A01C 21/00; B01J 20/24; B01J 20/22
USPC 47/58.1 SC; 252/194

(57) ABSTRACT

A composition is provided as a treatment to be added to landscaping material. The treatment includes glycerin and is applied to the landscaping material at a rate of about 0.3 pounds treatment per cubic yard (178 grams per cubic meter) of landscaping material. The treatment formulation may be at least 50% by weight glycerin mixed with a water carrier. The landscaping material may be any typical mulch material, such as a plurality of wood chips or other fibrous organic material. A colorant or other coating may be applied to the landscaping material along with the treatment.

### CROSS REFERENCE TO RELATED APPLICATION

The present disclosure claims priority to and the benefit of the filing date of U.S. Provisional Application No. 61/906,241, filed Nov. 19, 2013, which is herein incorporated by reference.

### FIELD OF THE INVENTION

The present invention relates to a landscaping material, such as fibrous mulch, having a treatment thereon for improving water management.

### BACKGROUND

Landscaping materials, such as wood mulch, are commonly placed over a soil surface around trees and plants to improve soil and plant growth conditions. The material typically is applied for the purposes of retaining moisture within the soil, minimizing weed competition for water and distributing water to the soil. Landscaping materials may also provide landscapes with an aesthetically pleasing, groomed appearance.

Typical landscaping materials may be comprised of a plurality of fragments, such as chips, shredded bark, shells, etc. The fragments may be made from grinding, chopping, or otherwise reducing bulk material into the desired form. Two major types of landscaping materials are inorganic and organic. Inorganic landscaping materials include various types of stone, lava rock, pulverized rubber, geotextile fabrics and other materials. Inorganic landscaping materials do not decompose and does not need to be replenished often. Because this type of material, does not decompose, it does not significantly improve soil structure, add organic materials or provide nutrients. Organic landscaping materials are usually derived from plants and may include wood chips, pine needles, bark, cacao hulls, leaves, compost mixtures and a variety of other mulching products. Organic mulches decompose in the landscape at different rates depending on the material, climate and other factors.

The marketability of landscaping materials/mulches, particularly for decorative purposes, often depends on the appearance of the product and its color. Coloring agents or coatings have been used to artificially color landscaping material for a number of years. The coloring agents allow for greater control and uniformity in the appearance. The coloring agents are commonly sold in concentrated form and are mixed with water prior to their introduction to the landscaping material.

The colorants applied to landscaping materials may also include admixes, such as resins and surfactants. U.S. Pat. No. 4,932,156 to Underwood describes a method for controlling the color of mulch that may become faded due to prolonged exposure to light and ambient weather conditions. The Underwood patent describes a composition generally comprised of a pigment or dye, a binding additive, glycol and water. This Underwood patent is herein incorporated by reference.

A number of machines exist for adding colorants to landscaping material. U.S. Pat. No. 6,551,401 to Winistorfer et al. describes a machine for coloring landscaping material having multiple mixing chambers. A first mixing chamber includes spraying of the coating material onto the landscaping material and a second chamber wherein the coating is further applied in the form of an aerosol. Paddles supported by arms are secured to a rotating shaft within the mixing chambers to mix the landscaping material during the coating process. This Winistorfer patent is herein incorporated by reference.

Another machine for controlling the addition of colorants, coatings and other treatments to landscaping material is known as the Sahara® Pro coloring system, sold by BASF Corporation of Florham Park, N.J. The apparatus includes a mixer having a mixing chamber and means for feeding a controlled quantity of particulate material into the mixing chamber. An agitator is provided in the mixing chamber for mixing and conveying the particulate material to a discharge outlet. A coating feed system is also provided for delivery of a coating into the mixing chamber during mixing by the agitator, with the coating delivered as an atomized spray. A controller is provided for adjusting the flow of the coating into the mixing chamber based on the volumetric feed rate of the particulate material. A system is also provided for controlling the mixing of one or more additional treatments or additives within the process.

Generally, landscaping materials/mulch provide many functions related to water management. To most effectively perform these functions, the landscaping material preferably provides a fairly uniform moisture level throughout the ground or soil bed. In addition, the landscaping material covering the soil should direct water evenly into the root system of the adjacent trees and plants, preventing the water from running off. For a few reasons, conventional organic mulch often does not create uniform moisture levels nor efficiently distribute water evenly over the soil bed. For example, the difference in the surface energy of organic mulch and water typically causes the water to “bead-up” or form droplets on the surface of the landscaping material. Where the surface energy of a liquid is greater than the substrate on which the liquid is applied, the liquid is likely to bead-up on the surface of the substrate. Conversely, where the surface energy of the substrate is greater than the surface energy of the applied liquid, the liquid is more likely to “wet” or coat the surface of the substrate.

One previously proposed treatment for landscaping materials, such as organic mulch, is defined in US 2010-0229461 to Oien. The treatment includes the combination of a structured oligomeric siloxane and a polyalkylene glycol, preferably coupled with a solvent. This combination forms a concentrate that may be mixed with water for treating the landscaping material and may further be added to a colorant material. The treatment reduces the surface tension of water added to the landscaping material, and thus serves to promote wetting of the surface of the landscaping material. The wetted material is farther capable of releasing the water into the covered soil bed. The Oien publication also discloses methods for testing the effectiveness of a landscaping material in conditions similar to its normal use to determine its ability to retain water and to control the distribution of water applied to its upper surface. This Oien publication is herein incorporated by reference.

### SUMMARY OF THE INVENTION

In one aspect of the invention, a composition for a treatment is provided to a landscaping material. The treatment includes glycerin and is applied to the landscaping material. The glycerin within the treatment is applied in the range of at least about 0.011 pounds (LB) to 2.85 LB per cubic yard (cu.yd.) (6.5 grams (g) to 1689 g per cubic meter (m³)) of landscaping material. The preferred amount of glycerin is about 0.171 LB/cu.yd. (101 g/m³). The treatment formulation is at least 50% by weight glycerin mixed with a carrier, which is preferably water. The preferred treatment formulation is 57% by weight glycerin to 43% by weight of the water carrier. The glycerin is at least Technical grade and is preferably USP grade. The landscaping material may be any typical mulch material, such as a plurality of wood chips or other fibrous organic material. A colorant may be applied to the landscaping material along with the treatment composition.

### BRIEF DESCRIPTION OF THE DRAWING

For the purpose of illustrating the invention, the drawing shows an application condition for the invention as presently preferred. However, it should be understood that the invention is not limited to the precise arrangement shown in the drawings.

FIG. 1 is a partial cross-sectional view of a landscaping system with a tree planted in the ground, a landscaping material covering the surrounding ground and a water distribution pattern within the landscaping material.

### DETAILED DESCRIPTION

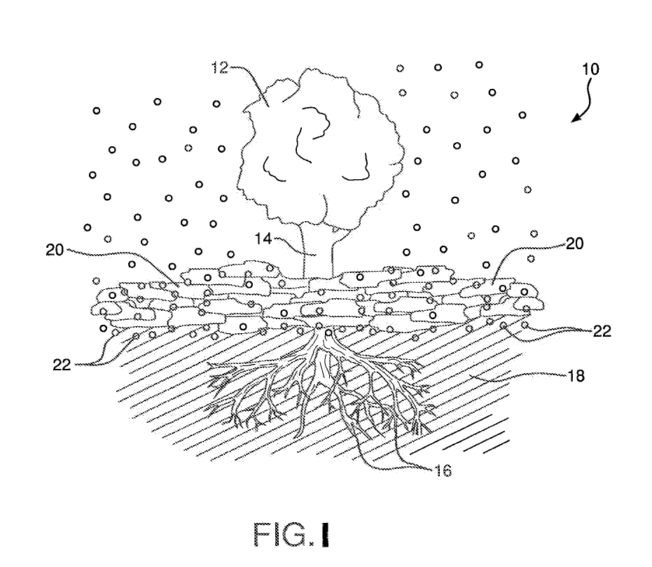

Referring now to the drawings, wherein like numerals identify like elements, there is shown in FIG. 1 a landscaping system using landscaping material/mulch for covering the soil surrounding a tree. As used herein, “landscaping material” refers to any ground cover material, whether organic or inorganic, natural or synthetic, used to cover, preserve, maintain, restore or otherwise treat the ground or soil. Preferably, the landscaping material is mulch comprised of a plurality of units or fragments of a natural or organic material, such as wood chips, pellets, granules, scraps or an aggregate thereof.

There are many ways of applying landscaping material for decoration and for preserving the life of plants and trees. In FIG. 1, the landscaping system 10 is shown having a tree 12 with a projecting trunk 14 supported by a root structure 16, positioned beneath the ground or soil 18. The landscaping material 20 at least partially covers the soil 18 which retains the root structure 16. The landscaping material 20 is applied over the soil 18 such that the material 20 at least partially surrounds the tree 12. The generally recommended depth of landscaping material 20 is about 2-4 inches (51-102 mm). The landscaping material 20 is typically intended to retain moisture in the covered soil 18, for example, by preventing evaporation. The landscaping material 20 also controls weed growth by blocking sunlight to the soil 18. In addition, the landscaping material 20 insulates the soil 18, retaining warmth during cool air temperatures and cooling the soil 18 during warm air temperatures.

In FIG. 1, the landscaping material 20 uniformly directs the water flow 22 through the bed. When water 22 is applied to the surface of the landscaping material 20, it tends to spread over the bed. This spread of water serves to wet the surface of the landscaping material 20 and more deliberately move water into the underlying layers. As landscaping material 20 spreads the water, it acts to temporarily hold water. The water 22 is then released to the soil 18 and root structure 16.

As discussed herein, the surface tension or energy of organic materials, such as wood chips, typically used for landscaping materials is generally much less than the surface tension or energy of water. Because of this differential in surface energy, water will normally bead-up on the surface of the material, conglomerate and start to channel. In such cases, an uneven water distribution will occur. it is preferred that the water wet the surface of the landscaping material. The wetting process serves to temporarily hold the water and then direct it to the soil retaining the root structure of the adjacent plants and trees. A treatment or coating applied to the landscaping material is preferably intended to enhance one or more water management properties of the landscaping material verses a non-treated material. Water management properties include saturation (a measure of the amount of water needed to saturate the landscaping material), water holding capacity (a measure of the amount of water that the landscaping material may hold after a defined water application—such as a rain shower), water retention (a measure of the amount of water held over time in the landscaping material), water retention in the covered soil (a measure of the amount of water held over time in the soil covered by the landscaping material).

The landscaping material of the present invention includes a treatment that promotes moisture retention within the landscaping material. The retained water later passes into the soil and plant roots.

Preferably, the treatment composition to be applied to the landscaping material comprises glycerin, with the glycerin being applied at a rate within the range of at least about 0.011 pounds (LB) per cubic yard (cu.yd.) to about 2.85 LB/cu.yd. (6.5 g to 1689 g/cubic meter (m³)) of landscaping material. Preferably, the treatment is applied as a combination of glycerin and a carrier, with the preferred carrier being water. The formulation of the treatment is preferably about 57% by weight glycerin with the remainder being the carrier (possibly along with other materials). A USP grade of glycerin (99.7% pure) is preferred. Technical grade glycerin (97% pure) may also be used with comparable results. (A Crude grade glycerin is not normally desirable, due to its broad purity range, typically 20% to 80%, and the need for reformulation to create adequate results.) The glycerin is preferably mixed with water—43% by weight—as a carrier. The addition of the water carrier is used to make the treatment easier to handle and apply. Additional water or another carrier material may be included in the treatment formulation or be added at the time of treatment application. Other materials may be provided in the final formulation. The preferred rate of treatment application to the landscaping material is about 0.171 LB glycerin per cu.yd. (101 g/m³) of landscaping material.

In the preferred combination, the treatment is applied to a landscaping material formed by ground “chips” of hardwood or softwood material. A colorant may similarly be applied to the landscaping material/mulch, either as a base coating (prior to application of the present treatment) or in combination with (at the same time as) the present treatment. Typical colorant compositions are applied to landscaping materials at a greater rate than that identified for the present composition. Colorants are often applied at a rate greater than about 0.5 LB colorant per cu.yd. (296 g/m³) landscaping material, although greater rates are typical (with the variation being dependant on the intensity of the desired color, the colorant material/color, the equipment used to apply the colorant, the type of landscaping material, etc.). The present composition may also be applied along with other chemicals for treating the landscaping material. These other chemicals may assist in feeding the root structure and the plant during the useful life of the landscaping material. Other chemical treatments are known in the art.

Functionally, the landscaping material and treatment combination is “wetted” by the water added to the applied landscaping material. Because of the treatment, the landscaping material “holds” the water in position. The treated landscaping material preferably releases the water over time, dependent on environmental and soil conditions. This combination provides a uniform flow of water over the landscaping material bed without significant surface run-off. In addition, the combination provides the ability to retain moisture longer (than either non-colored mulch or mulch with most conventional colorants, coatings or treatments) and results in an appearance improvement. Consumers prefer fresh-looking landscaping material, which appears moist and richer in color. Preferably, the treatment does not significantly alter the look of any added colorant.

Various tests were performed to test the water management properties of treated landscaping materials. The testing apparatus in a number of tests included a mulch retaining tray, which is perforated with a plurality of approximately ¼ inch (6 mm) holes in the bottom surface. Three inches of mulch (76 cm) is filled within the mulch tray. The mulch is typically dried to a set moisture range at the start. The mulch tray is positioned below one or more nozzles to spray water at a controlled rate, simulating rain, onto the surface of the mulch within the tray.

In one set of tests applied to landscaping material including the present treatment composition, measurements are taken to determine the time and amount of water required—at a fixed flow rate—to saturate the landscaping material retained within the mulch tray apparatus. Saturation is determined by probing of the landscaping material layers at multiple locations and making a visual inspection of the condition of the landscaping material indicates the extent of saturation. (Dry spots essentially indicate a lack of saturation in the bed of landscaping material.) The probing is performed at uniform increments, such as after every application of a fixed amount of water (for a set time at the set water application rate).

In the table below, there is shown the averaged results of a saturation test where water is applied to a 3 inch (76 mm) bed of non-treated mulch and treated mulch. The average of non-treated mulch and treated mulch is represented by the inclusion of hardwood and softwood mulches, with and without colorant. The colorant is defined as formulated red and black pigments, applied at a rate of 3 LB/cu.yd (1779 g/m³) on the mulch. The mulch treatment was applied with a composition of 0.3 LB/cu.yd, (178 g/m³) with the composition being 57% by weight of glycerin and 43% by weight of a water carrier.

TABLE 1

| | Inches (mm) of water | |
|---|---|---|
| | (average) to saturate 3 inch | |
| | (76 mm) mulch bed | % Change |
| Average of non-treated | 5.44 (138) | |
| mulch | | |
| Average of treated mulch | 1.14 (29) | 79 |

As shown by Table 1, the addition of the treatment (“Treated”) shows an improvement in saturation, in that less water is required in order to saturate the mulch bed. In effect, the mulch retains and distributes the water more efficiently. In the non-treated samples, there is significant water run off, leaving portions of the bed in a dry state, which is only overcome by adding additional water to the bed.

In the table below, there is shown the averaged results of a saturation test where water is applied to a 3 inch bed of mulch treated with varying concentrations of the treatment composition. This test was performed without a colorant included on the landscaping material (hardwood mulch). The rate of treatment applications is provided in total amount of treatment applied, with the formulation included 57% by weight of glycerin and 43% by weight of a water carrier.

TABLE 2

| | Inches of water (average) | |
|---|---|---|
| | to saturate 3 inch (76 mm) | |
| Treatment Rate | mulch bed | % Change |
| Non-treated | 7.32 (185.9 mm) | |
| 0.03 LB/cu.yd. (17.8 g/m³) | 1.10 (27.9 mm) | 85 |
| 0.3 LB/cu.yd. (178 g/m³) | 0.55 (14.0 mm) | 92 |
| 3 LB/cu.yd. (1778 g/m³) | 0.55 (14.0 mm) | 92 |

As shown by Table 2, the addition of the treatment provides an improvement in saturation, in that less water is required in order to saturate the mulch bed over the non-treated hardwood mulch. The improvement is seen at the lowest applied rate. At a rate of 0.03 LB/cu.yd. (17.8 g/m³) there is a significant reduction in the amount of water required for saturation. Increasing the treatment rate shows increases the saturation. The rate of 0.3 LB/cu.yd. (178 g/m³) shows a further improvement over the lower rate tested. A further increase in rate to 3 LB/cu.yd. (1778 g/m³) shows no additional improvement within the landscaping materials tested. The preferred rate is contemplated to be the point where the amount of improvement in saturation levels off. For varying materials, it is anticipated that the significant improvement would occur with a rate of treatment application in the range of about 0.011 LB to 2.85 LB glycerin per cu.yd. (6.5 g to 1689 g/m³) of landscaping material. The additional carrier, e.g., water, may be added to the formula at any rate for ease of handling, with the preferred rate being about 57% by weight glycerin to about 43% by weight carrier.

In a further test of the contemplated treatment, the weight of the watered landscaping material is determined after the addition of 1 inch (25.4 mm) of water to a bed of landscaping material in a simulated rain event. This test captures the water holding capacity of the treated and non-treated mulch. In this testing, the mulch was applied with the contemplated treatment at a rate of 0.3 LB/cu.yd, (178 g/m³) with the composition being 57% by weight of glycerin and 43% by weight of a water carrier. The colorant on the mulch was applied at a rate of 3 LB/cu.yd. (1778 g/m³).

TABLE 3

| | Water (LB) (g)/ | |
|---|---|---|
| | Pound of mulch (g) (average) | % Change |
| Average of non-treated | 0.56 (0.56) | |
| mulch | | |
| Average of treated mulch | 0.87 (0.87) | 36 |

The data in Table 3 shows that with the addition of 1 inch of water to a mulch bed, there is an increase in the water held within the bed when the mulch is treated. In the data above, the rate of water added is defined as a ratio with the weight of the mulch in the bed. This weight ratio is considered to be more consistent measurement, since the amount of wood (or similar) material may vary considerably within a given mulch volume. A comparable improvement is shown when the treated mulch has been coated at the same time with colorants, which are typically formulated as a combination of red and black pigments. The presence of certain additives within the colorants, such as surfactants, may affect the results.

In the table below, there is shown the averaged results of another water holding capacity test where the mulch is treated with varying concentrations of the treatment composition. This test was performed on the hardwood (with the rate of treatment applications provided in total), with the formulation included 57% by weight of glycerin and 43% by weight of a water carrier. This test was performed without a colorant and included the addition of ½ inch of water in the simulated rain event.

TABLE 4

| | Water (LB) (g)/Pound of | |
|---|---|---|
| Treatment Rate | mulch (g) (average) | % Change |
| Non-treated | 0.23 (0.23) | |
| 0.03 LB/cu.yd. (17.8 g/m³) | 0.64 (0.64) | 64 |
| 0.3 LB/cu.yd. (178 g/m³) | 0.59 (0.59) | 61 |
| 3 LB/cu.yd. (1778 g/m³) | 0.62 (0.62) | 63 |

The data in Table 4 shows that the addition of the treatment provides an improvement in water holding within landscaping material (hardwood mulch). More water is held by the mulch when the treatment is added, as compared to a non-treated mulch material. At an overall treatment application rate of 0.03 LB/cu. yd. (17.8 g/m3) there is a significant increase in weight due to the water held within the mulch. The rate of 0.3 LB/cu. yd. (178 g/m³) does not show a significant change relative to the lower treatment application rate. A further increase in the treatment rate to 3 LB/cu. yd. (1778 g/m³) again does not create further improvement for the mulch material tested. The preferred rate considering the water retention quality would typically be set at the point where the amount of improvement in saturation levels off (for the applied landscaping material). For various materials, it is anticipated that an improvement would occur with a rate of treatment application in the range of about 0.011 LB glycerin per cu.yd. (6.5 g/m³) of landscaping material. The additional carrier, e.g., water, may be added to the formula at any rate for ease of handling, with the preferred rate being about 57% by weight glycerin to about 43% by weight carrier. No significant improvement is contemplated at a rate greater than about 2.85 LB glycerin per cu.yd. (1689 g/m³) of landscaping material, with the peak potentially being lower for this water retention quality.

The landscaping material coated with the present composition conserves water because less water is required to cause saturation. The amount of water conserved is directly related to how much water it takes to saturate a bed of landscaping material. Further, the treatment causes the landscaping material to retain water, as compared to non-treated mulch. Hence, the treatment will add to the effectiveness of typical landscaping materials, whether they are in a raw/non-treated condition or with colorant added.

A further desirable water management property is water retention. It is desirable that the mulch material retain water over time. In Table 5, the weight of the landscaping material after the addition of 1 inch (25.4 mm) of water from the test reported in Table 3 is again weighed after an elapsed time of 7 days. As noted before, the mulch was applied with the treatment at a rate of 0.3 LB/cu.yd, (178 g/m³) with the treatment composition being 57% by weight of glycerin and 43% by weight of a water carrier. The colorant on the mulch was applied at a rate of 3 LB/cu.yd. (1778 g/m³).

TABLE 5

| | Water (LB) (g)/Pound of | |
|---|---|---|
| | Mulch (g) (average) | % Change |
| Average of non-treated | 0.35 (0.35) | |
| mulch | | |
| Average of treated mulch | 0.61 (0.61) | 43 |

The data in Table 5 shows that after 7 days from the addition of 1 inch (25.4 mm) of water to a controlled mulch bed, there is an increase in the water held within the bed when the mulch is treated. A comparable improvement is shown when the treated mulch has been previously coated with a colorant (formulated red and black pigments). Hence, the treatment serves to increase the water management property of water retention within landscaping material.

Additional testing was performed to determine if the treatment provides advantages in water management with respect to water retention in the soil covered by a mulch bed. The testing procedure placed soil in pots with 3 inches (76 mm) of mulch covering the soil. The weight of the pots was determined at the initial (dry) start. Water was applied to the pots to saturation (approximately 1.1 gallons of water). The pots were then left standing for 24 hours. The weight of the pots was tested at the end of the 24 hour period. The weight measurement was repeated on day 4 and day 7. The data reported below in Table 6 includes multiple tests with a total of 63 pots. A comparison is made between non-treated mulch and treated mulch. The test data demonstrates that soil with treated mulch retained 21% more water than soil with non-treated mulch.

TABLE 6

| | Water Content (LB) (g) | |
|---|---|---|
| | on day 7 | % Change |
| Non-treated mulch | 1.05 (476) | |
| Treated mulch | 1.33 (603) | 21 |

The treatment as described may be applied to the landscaping material by any number of methods. Two apparatus for such applications include the Sahara® X series coloring system and the Sahara® Pro coloring system, each sold by BASF Corporation of Florham Park, N.J. Other treatment and coating apparatus are known and may he utilized. The treated landscaping material may be distributed in bulk or may be placed in bags and distributed through normal retail channels.

Although the contemplated invention has been described and illustrated with respect to exemplary embodiments, it should be understood by those skilled in the art from the foregoing that various other changes, omissions and additions may be made therein and thereto, without parting from the spirit and scope of the present invention.

1. A composition comprising:
a landscaping material, and
a treatment comprising glycerin and a carrier,
wherein the treatment is applied to the landscaping material within the range of at least about 0.011 pounds (LB) glycerin to about 2.85 LB glycerin per cubic yard (cu.yd.) (6.5 grams (g) to 1689 g per cubic meter (m³)) of landscaping material.

2. The composition of claim 1 wherein the treatment is formulated at about 57% by weight glycerin to about 43% by weight carrier.

3. The composition of claim 2 wherein the carrier is water.

4. The composition of claim 1 wherein the glycerin is USP grade.

5. The composition of claim 1 wherein landscaping material is a plurality of chips of a fibrous organic material.

6. The composition of claim 5 wherein the fibrous organic material is wood.

7. The composition of claim 1 further comprising a colorant applied to the landscaping material.

8. The composition of claim 7 wherein the colorant is applied to the landscaping material at a rate of at least about 0.3 LB (178 g/m³) colorant per cubic yard of landscaping material.

9. The composition of claim 1 wherein the treatment is applied to the landscaping material at a range of about 0.017 LB to about 0.171 LB glycerin per cu.yd. (10.1 to 101 g/m³) landscaping material.

10. The composition of claim 1 wherein the carrier is water and the treatment is formulated at about 57% by weight glycerin to about 43% by weight carrier.

11. The composition of claim 10 wherein the glycerin is at least Technical grade.

12. A composition comprising:
landscaping material formed from a plurality of chips of a fibrous organic material, and
a treatment comprising glycerin and water and formulated by a ratio of about 57% by weight glycerin to about 43% by weight water,
wherein the treatment is applied to the landscaping material at a rate in the range of about 0.011 LB to 2.85 LB glycerin per cu.yd. (6.5 g to 1689 g per m³) of landscaping material.

13. The composition of claim 12 wherein the glycerin is at least Technical grade.

14. The composition of claim 13 wherein the treatment is applied to the landscaping material at a range of about 0.017 LB to about 0.171 LB glycerin per cu.yd. (10.1 to 101 g/m³) landscaping material.

15. The composition of claim 14 wherein the fibrous organic material is wood.

16. A composition comprising:
a landscaping material, and
a treatment applied to the landscaping material to enhance the water management properties of the landscaping material.

17. A composition as in claim 18, wherein the treatment comprises glycerin and a carrier and wherein the treatment is applied to the landscaping material at a rate in the range of about 0.011 LB to 2.85 LB glycerin per cu.yd. (6.5 g to 1689 g per m³) of landscaping material.

18. The composition of claim 17 wherein the glycerin is at least Technical grade.

19. The composition of claim 17 wherein the treatment is applied to the landscaping material at a range of about 0.017 LB to about 0.171 LB glycerin per cu.yd. (10.1 to 101 g/m³) landscaping material.

20. The composition of claim 19 wherein the carrier is water and the treatment is formulated at about 57% by weight glycerin to about 43% by weight water.

21. A method of managing water properties within plants or trees, the method comprising the steps of:
providing a volume of landscaping material,
applying a treatment to the landscaping material, the treatment comprising glycerin and a carrier, wherein the treatment is applied to the landscaping material at a rate in the range of about 0.011 LB to 2.85 LB glycerin per cu.yd. (6.5 g to 1689 g per m³) of landscaping material, and
covering the soil adjacent to the plants or trees with the treated landscaping material.

22. The method of claim 21 wherein the glycerin is at least Technical grade.

23. The method of claim 21 wherein the treatment is applied to the landscaping material at a range of about 0.017 LB to about 0.171 LB glycerin per cu.yd. (10.1 to 101 g per m³) landscaping material.

24. The method of claim 21 wherein the carrier is water and the treatment is formulated at about 57% by weight glycerin to about 43% by weight water.

25. The method of claim 21 wherein the landscaping material is formed of a plurality of fragments of a fibrous organic material.
